(19) United States
(12) Patent Application Publication
(10) Pub. No.: US 2008/0312828 A1
(43) Pub. Date: Dec. 18, 2008

(54) SYSTEM AND METHOD FOR PROVIDING DIRECTIONS

(76) Inventors: Joseph P. Marsalka, Dublin, OH (US); Randall E. Willaman, Powell, OH (US)

Correspondence Address: RONALD J. KOCH, 698 MORRISON RD., SUITE B, COLUMBUS, OH, 43213, US

(21) Appl. No.: 12/016,908

(22) Filed: Jan. 18, 2008

Related U.S. Application Data
(63) Continuation-in-part of application No. 11/354,510, filed on Feb. 15, 2006.
(60) Provisional application No. 60/885,494, filed on Jan. 18, 2007.
(60) Provisional application No. 60/917,381, filed on May 11, 2007.

(51) Int. Cl. G01C 21/32

(52) U.S. Cl. 701/211

(57) ABSTRACT

A method for providing geographic directions having the steps of: providing a server system capable of electronic communication with a communication device; the server system, receiving a call from a communication device, the communication device being under the control of a user, receiving human speech in the form of electronic information from the communication device, recording the human speech, converting the human speech into electronic text and attempting to match the text to a destination address on a map server, upon failing to match the text to a destination address on the map server, transmitting the recorded speech to a human operator who listens to it and ascertains a destination address; upon receiving the ascertained destination address, the server system rendering a map from the location of the communication device to the destination address, and transmitting the map to the communication device.

The present application is related to the co-pending provisional patent application Nos. 60/917,381 of JOSEPH P MARSALKA, et al, filed May 11, 2007, entitled “System And Method for Providing Directions”; and 60/885,494 of JOSEPH P MARSALKA, et al, filed Jan. 18, 2007, entitled “Improved System And Method For Providing Geographic Directions”, and based on which priority is herewith claimed under 35 U.S.C. 119(e) and the disclosure of which is incorporated herein by reference in its entirety as if fully rewritten herein.

The present application is related to the co-pending patent application Ser. No. 11/354,510, of JOSEPH P MARSALKA, et al, filed Feb. 15, 2006, entitled “System And Method For Providing Geographic Directions”, and based on which priority is herewith claimed under 35 U.S.C. 120 and the disclosure of which is incorporated herein by reference in its entirety as if fully rewritten herein.

### BACKGROUND AND SUMMARY

The Global Positioning System (GPS) is being used to provide data that has never been available before in the quantity and degree of accuracy that the GPS makes possible. For example, scientists are using the GPS to measure the movement of the arctic ice sheets, the Earth's tectonic plates, and volcanic activity.

GPS receivers are becoming consumer products. In addition to their outdoor use (hiking, cross-country skiing, ballooning, flying, and sailing), receivers can be used in cars to relate the driver's location with traffic and weather information.

The GPS (Global Positioning System)

The GPS (Global Positioning System) is a “constellation” of well-spaced satellites that orbit the Earth and make it possible for people with ground receivers to pinpoint their geographic location. The location accuracy is anywhere from 100 to 10 meters for most equipment. Accuracy can be pinpointed to within one (1) meter with special military-approved equipment. GPS equipment is widely used in science and has now become sufficiently low-cost so that almost anyone can own a GPS receiver.

The GPS is owned and operated by the U.S. Department of Defense but is available for general use around the world. 21 GPS satellites and three spare satellites are in orbit at 10,600 miles above the Earth. The satellites are spaced so that from any point on Earth, four satellites will be above the horizon.

Each satellite contains a computer, an atomic clock, and a radio. With an understanding of its own orbit and the clock, it continually broadcasts its changing position and time. (Once a day, each satellite checks its own sense of time and position with a ground station and makes any minor correction.)

On the ground, any GPS receiver contains a computer that “triangulates” its own position by getting bearings from three of the four satellites. The result is provided in the form of a geographic position—longitude and latitude—to, for most receivers, within 100 meters.

If the receiver is also equipped with a display screen that shows a map, the position can be shown on the map. If a fourth satellite can be received, the receiver/computer can figure out the altitude as well as the geographic position. If you are moving, your receiver may also be able to calculate your speed and direction of travel and give you estimated times of arrival to specified destinations.

A-GPS

GPS uses a network of 24 satellites to triangulate a receiver's position and provide latitude and longitude coordinates. Although GPS provides excellent position accuracy, position fixes require lines of sight to the satellites. In urban areas, when the user is located in “urban canyons”, under heavy tree cover, or even indoors, Assisted GPS, or A-GPS, is a technology that uses an assistance server to cut down the time needed to find the location. It is becoming more common and it's commonly associated to Location Based Services (LBS) over cellular networks.

A-GPS differs from regular GPS by adding another element to the equation, the Assistance Server. In regular GPS networks there are only GPS satellites and GPS receivers. In A-GPS networks, the receiver, being limited in processing power and normally under less than ideal locations for position fixing, communicates with the assistance server that has high processing power and access to a reference network. Since the A-GPS receiver and the Assistance Server share tasks, the process is quicker and more efficient than regular GPS, albeit dependent on cellular coverage.

Assisted GPS describes a system where outside sources, such as assistance server (Mobile Location Server) via a network, help a GPS receiver perform the tasks required to make range measurements and position solutions. The assistance server has the ability to access information from the reference network and also has computing power far beyond that of the GPS receiver. In this case, the assistance server communicates with the GPS receiver on the mobile phone on a network. With assistance from the network, the receiver can operate more quickly and efficiently than it would unassisted, because a set of tasks that it would normally handle is shared with the assistance server. The resulting AGPS system boosts performance beyond that of the same receiver in a stand-alone mode.

Ordinarily, a standard GPS device needs to have a clear line-of-sight to at least four GPS satellites before it can calculate its position. In addition, it needs enough processing power to transform the data streams from the satellites into a position. Using AGPS, the cell tower will receive the signal from several satellites, and perform the calculations. That way, all that is required is for the phone to relay any GPS signal it receives to the tower.

“L2-Civil”

The new signal is known as L2C and is designed with higher power so GPS receivers will work better in areas surrounded by large buildings as well as indoors. This facilitates GPS chipset makers to produce receivers that use less power to acquire the same signal strength, opening the doors to have GPS devices incorporated into smaller and lower power devices.

Although a myriad of uses are apparent, the current state of the art does not adequately provide a way to efficiently and economically allow a user to take advantage of GPS (or the like) and get geographic directions using a cell phone (communication devices include cell phones). It is advantageous to obviate the need to purchase separate devices for obtaining directions. Accordingly, an invention is disclosed that eliminates problems inherent in current methods and systems while achieving advantages over them.

One embodiment of the invention would apply to the process of providing directions to a person simply by the person speaking their destination into any communication device (i.e. cell phone or personal digital assistant (PDA)) and receiving the directions in the form of an audio signal with verbal directions, map and/or text directions. The communication device would typically be a cell phone or PDA but could be any mobile device that could support a Voice over Internet Protocol (VoIP) device such as a personal computer and a headset.

The wireless connection used by the mobile communication device would be typically provided by a cellular telephone service provider, but could also apply to wireless networks in the office.

The invention will:

a) Support the ability to retrieve global positioning coordinates from the caller's communication device hardware and be able to transmit the coordinates to a computer system for processing.

b) Enable the caller to speak the desired destination into the communication device for capture by an Interactive Voice Response (IVR) system.

c) The IVR system will have speech technology to confirm back to the caller the desired destination, and upon confirmation, use the caller's current location (as defined by the received GPS coordinates) in conjunction with the destination information and provide directions in various forms including, but not limited to, rendering a digital map appropriate for processing and display on the caller's communication device, an audio signal or audio file containing verbal instructions, or textual information.

d) The invention will transmit the directions (in various electronic forms, in combination or alone, including a digital map, verbal directions in the form of an audio signal, and textual directions) back to the caller's communication device. Alternatively, the directions could be sent back to a facsimile machine or computer.

e) Should the IVR system be unable to find the requested destination, or be unable to properly interpret the caller's speech, or for any other reason be unable to locate the destination, an audio recording of the caller's recited destination will be stored in memory and forwarded to an operator. The operator will then decipher the directions and manually input the data so as to cause the proper address to be retrieved from the server. Alternatively, the caller could be directed to a human operator for a live conversation. The human operator will work directly with the caller to develop the requested destination.

Software:

The invention will be able to be utilized by any device that has the ability to download and execute an application via a wireless connection.

The application will include software developed for execution on mobile devices (typically including but not limited to cellular telephones and PDA's) as long as the mobile device contains technology to report location coordinates such as those used by the Global Positioning System. The application will also include software designed to execute on other general purpose computers to support the receipt of the GPS coordinates from the mobile device and to process this information for the purpose of sending directions (in various forms as discussed throughout) back to the caller.

The operating system environments or virtual machines used to execute the software on the mobile devices will include, but not be necessarily limited to: Java (trademark), J2ME—(Java 2 Platform, Micro Edition) (trademark), Microsoft Windows XP, 2000, Mobile, or CE (trademark), Binary Runtime for Wireless Environment (BREW™) (Qualcomm) (trademark).

The communication protocols/definitions to transmit the information to/from the mobile communication device would include but not necessarily be limited to: Cellular data link control (CDLC), WAP 1.2.1, WAP 2.0, SMS, SMS MT, SMS MO, GPRS, Java MIDP 1.0, CDLC 1.0, WML/XHTML dual stack.

### Description of Operation of One Embodiment

There are four major components to the invention; a mobile device, a wireless network, a computerized interactive voice response system (IVR), and a human being acting as a backup to the IVR. The components are identified below:

1. A mobile device that can run a computerized program that can electronically receive information in the form of instructions and directions to a destination and can process the directions and provide human speech instructions to the caller.

2. A wireless network is either a cellular telephone network or other electronic network that allows the transmission of voice and electronic information between computer devices.

3. An IVR system that can electronically detect and process human speech and then render information back to the caller automatically based on the content of the speech.

4. A human being as the failsafe for processing the information from the caller, either using an audio recording of the user's input directions or in direct communication with the user, should the IVR system be unable to process the request.

The flow of the invention is as follows:

a) The caller can dial a phone number on the mobile device and, when instructed, speak the desired destination into the communication device for capture by an Interactive Voice Response (IVR) system. Instead of dialing the phone number, the caller could also speak the telephone number (or information necessary to connect the mobile device to the server).

b) The IVR system will have speech interpretation technology to confirm back to the caller the desired destination, and upon confirmation, use the caller's current location (as defined by the received GPS coordinates) in conjunction with the destination information to provide the electronic information necessary to guide the user to the desired destination. The electronic information could be in the form of a rendered digital map appropriate for processing and display on the caller's communication device or verbal directions in the form of an audio signal, or textual information.

c) The invention will transmit the electronic information (in proper form, including distances if necessary) back to the caller's communication device.

d) Should the IVR system be unable to automatically determine the destination address, the caller will be directed to a live agent for assistance.

The mobile device should have the ability to receive electronic information from another computer server. The electronic information sent by the server will be used by the mobile device to guide the caller to the final destination. One embodiment comprises the electronic information being in the form necessary to cause the user to hear verbal, step-by-step, directions upon the user approaching relevant nodes (e.g. street intersections). Thus, the user is directed where to turn the vehicle, etc without having to look at a map or otherwise divert his or her attention from the road.

Another embodiment comprises the computer server sending to the mobile device electronic information necessary to allow the user to see a graphical map on a display device (either alone or in combination with the user hearing verbal instructions). Implementation of the foregoing embodiments of the invention necessitate the mobile device be able to execute a program in its local memory that will provide the directions to the user in the desired form.

The mobile device (or other communication device such as cellular telephones and Personal Digital Assistants (PDA)) must posses the following characteristics:

a) have the capability to transmit voice out over a connection (cellular network, etc);

b) have the ability to connect to an external device (e.g. computer server);

c) be able to ascertain and communicate its location coordinates such as those provided by Global Positioning System, Assisted-GPS (A-GPS), or L2-Civil (L2C) receivers; and

d) have a computer processor and memory sufficient to allow the device to execute a software application.

The software application can be loaded onto the mobile device by various means. Examples include: downloading the software over a computer network (local wireless device, cellular telephone network, or hard wired Local Area Network) connection (sometimes referred to as “wireless”); installation from a separate computer, compact disk (CD) or other electronic memory device such as a ‘Memory Stick’ (sometimes referred to as a ‘storage device’.)

One embodiment of the present invention comprises the mobile device downloading the necessary software electronically over a wireless network. The following process is implemented by the user to achieve this.

a) Enable the ‘browser application’ or other specialized software application which is provided and built into the mobile device by the manufacturer;

b) Using the keypad buttons or keyboard on the mobile device the user will enter in either a Universal Resource Locator (URL) address, or, choose a predefined menu item defined by the provider of the wireless service and displayed as a menu item on the mobile device;

c) The result will be that the user's mobile device will be connected to a server computer that has been designed to enable a mobile device user to download software applications to the mobile device;

d) The server computer will transmit information to the mobile device the result being the user will see a display on the mobile device that will include a description of the software application and instructions on how to download the application to the mobile device;

e) The user will enable the download of the application to the mobile device using the mobile device's keypad, or other input method;

f) The application will be sent over the wireless network using the appropriate protocol from the server computer (or another computer that was instructed by the server computer to perform the download);

g) The mobile device will receive the download and store the application in local memory;

h) The user, upon receiving confirmation that the application has been successfully downloaded to the mobile device, will be instructed on how to start the application, or the application will start automatically;

i) The server computer will then disconnect from the mobile device and the mobile device will automatically install the application to enable it to execute on the mobile device. This may include having to turn the mobile device off and back on;

j) The application is now ready to use on the mobile device.

One embodiment comprises the installation of the software from a storage device using the same process as described above except that the mobile device does not need to connect to a server computer over a wireless network. The user will, using tools already available in the mobile device, be instructed on how to transfer the application from the storage device to the mobile device. The application will automatically install itself in the mobile device.

### Using the Invention

As part of a service offering, the caller (i.e. user) will be given a telephone number(s), or other information necessary to initiate contact with the server, when directions are needed. When the caller initiates the call it will be received and managed by an electronic Interactive Voice Response system, or IVR.

The IVR system is a collection of components including hardware and software that can detect an incoming phone call from an analog or digital phone network, retrieve the call, and provide automated services in response to spoken instructions (or instructions entered by other means such as a telephone keypad) received from the caller.

The IVR system and components can support a variety of processes and languages. The IVR system can detect the phone number dialed by the caller and, in response, answer the phone and provide computer generated human speech instructions in a particular language based on the number the caller dialed.

The processing of a call by the IVR system is as follows:

a) the caller initiates the call;

b) the IVR system detects the incoming call;

c) the IVR system picks up the call, when the call is picked up the IVR system also receives information which identifies the calling phone number;

d) The IVR system, using a text to speech application or prerecorded human speech, gives the caller instructions on how to use the service;

e) The caller speaks the requested destination into their mobile device;

f) The IVR system, using speech recognition technology, will interpret the callers requested destination;

g) The IVR system, using the text to speech application, will speak back the requested destination to the caller to confirm the request;

h) Once confirmed by the caller through a voice response or keypad entry, the IVR system will process the request;

i) Should the IVR system be unable to find the requested destination, or be unable to properly interpret the caller's speech, or for any other reason be unable to locate the destination, an audio recording of the caller' recited destination will be forwarded to an operator who would then decipher the directions and manually input the data so as to cause the proper address and directions to be retrieved from the server, (alternatively, the caller could be directed to a human operator who would work directly with the caller to develop the requested destination);

j) The request will be used by the IVR to search a computerized database that contains digital map information that can be searched by address, street name, city, town, state, zip code or latitude/longitude;

k) The result of the search of the database will be the return of the latitude and longitude information of the requested destination or other sufficient indice(s) necessary to provide directions to the destination;

l) The IVR system, using the caller's phone number, will request the caller's current latitude/longitude information;

m) Using the current location and the desired destination, the IVR system will generate the information necessary to provide directions to the destination, the necessary information could be one or more (alone or in combination) of the following: rendering a digital map to the destination, providing step-by-step instructions with verbal speech in the form of an electronic signal, or textual directions;

n) The necessary information will be transmitted electronically by the IVR system to the user's mobile device;

o) The IVR system will disconnect the call;

p) The caller will then enable the application running on the mobile device to navigate to the destination.

The directions can be in various forms including (in any combination): the application generates through a speaker verbal directions to the user from electronic data received from the server; the application plays an audio recording of the directions based on electronic data received from the server; the application generates textual or graphical information such as maps or words based on electronic data received from the server.

### Other Capabilities

In one embodiment of the invention, when the caller is assisted by a live agent (operator) the conversation between the agent and the caller can be recorded. The recording of the conversation will be available for playback by the caller. If the caller contacts the IVR system again the invention will provide the option to play back the last recorded conversation to the caller.

In one embodiment of the invention,

1) the caller calls into an IVR system;

2) the call is picked up and the caller defines his desired location;

3) the caller's speech is recorded either digitally or via a tape;

4) the speech recognition system attempts to determine the desired destination;

5) if the speech recognition system is successful, the directions are sent back to the caller;

6) if the speech recognition is not successful, the recording of the customer request is forwarded to an agent who determines the destination by listening to the recording and sends it back to the caller;

7) should the agent be unable to determine the destination from listening to the recording the agent can connect directly with the customer and converse with the customer;

As will be apparent, myriad electronic devices can be used as the “mobile device” component of the invention and can vary widely in their processing power, memory capacity, and other capabilities. Accordingly, it will be apparent that devices with greater capabilities can be responsible for more of the processes or tasks of the invention than devices with lesser capabilities—the remote server accomplishing the remaining tasks. The foregoing allocation of resources can be accomplished without departing from the spirit of the invention. In fact, such devices could effectively accomplish every task or process of the invention except the function of the human operator and necessary equipment and software to allow the operator to decipher the destination and perform the required input. For instance, a mobile device could have sufficient memory and processing capacity to allow it to perform the function of the map server and IVR/speech recognition. The mobile device could have on-board capabilities to accomplish this, such as a separate dedicated “chip” or alternatively a removable card (e.g. PCMCIA) with the necessary processing a memory capabilities. Moreover, a removable storage device (e.g. “SD” card or “mini SD” card) could provide added memory capacity. It is known in the art that dedicated chips can be easily programmed for specific applications and adapted to existing equipment.

One embodiment of the invention comprises a system and method wherein:

1) The caller makes a call to Twinklestar

2) The IVR picks up the call

3) The current geographic coordinates of the cell phone are received

4) The caller speaks the destination
a. If the IVR cannot understand the destination the call is sent to an operator
b. The operator listens to the request and enters in the destination address

5) The solution determines the cell phone's coordinates

6) The system creates a map based on the current coordinates and the destination coordinates

7) The map is downloaded to the cell phone

8) The phone renders voice directions to the caller

As an alternative to the server system (IVR) using the origin and destination addresses to render directions, the IVR can ascertain the destination address and the communication device (client system, etc.) ascertaining the origin address. the geographic coordinates of the destination could be transmitted back to the communication device and the device, after determining its current position via GPS/A-GPS, will render a map and/or verbal instructions to the caller to guide them to the destination.

One embodiment of the invention comprises a process wherein:

1) The caller makes a call to Twinklestar

2) The IVR picks up the call

3) The caller speaks the destination
a. If the IVR cannot understand the destination the recording of the request is sent to an operator
b. The operator listens to the request and enters in the destination address
c. If the operator cannot determine the destination from the recording, or the caller indicates they need help, the operator can speak directly to the caller.

4) The solution determines the geographic coordinates of the destination from either the IVR or the operator

5) The geographic coordinates are transmitted to the cell phone via an electronic message

6) The cell phone decodes the text message to get the destination coordinates

7) The cell phone uses a mapping program running in the cell phone to calculate a map from the cell phone's current position to the destination

8) The cell phone can either refer to internal maps to provide directions or can retrieve mapping information as needed during the trip to the destination

### BRIEF DESCRIPTION OF THE DRAWINGS

FIG. 1 depicts a block diagram of one embodiment of the invention

FIG. 2 depicts a block diagram of one embodiment of the invention

FIG. 3 depicts a block diagram of one embodiment of the invention

FIG. 4 depicts a block diagram of one embodiment of the invention

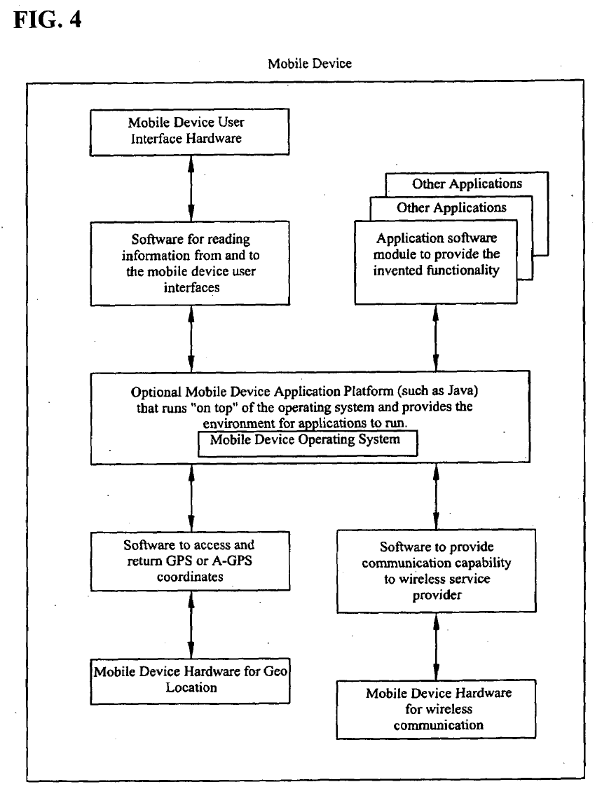

FIG. 5 depicts a flow diagram of one embodiment of the invention

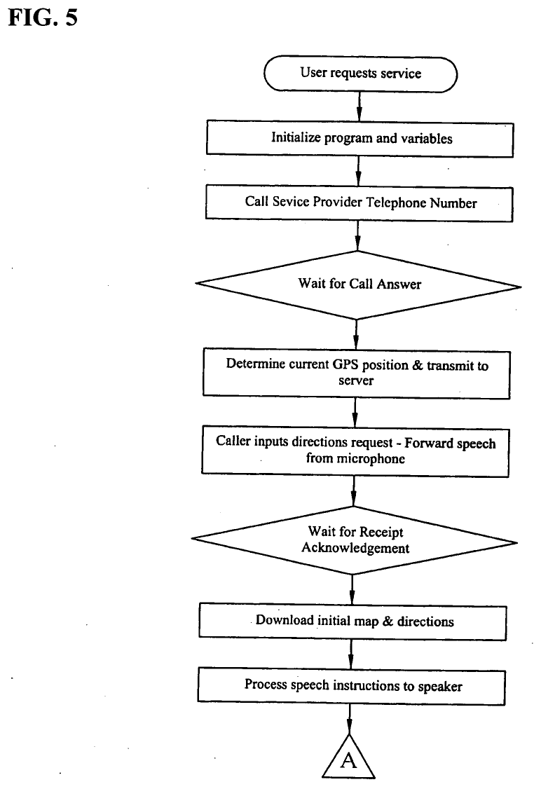

FIG. 6 depicts a flow diagram of one embodiment of the invention

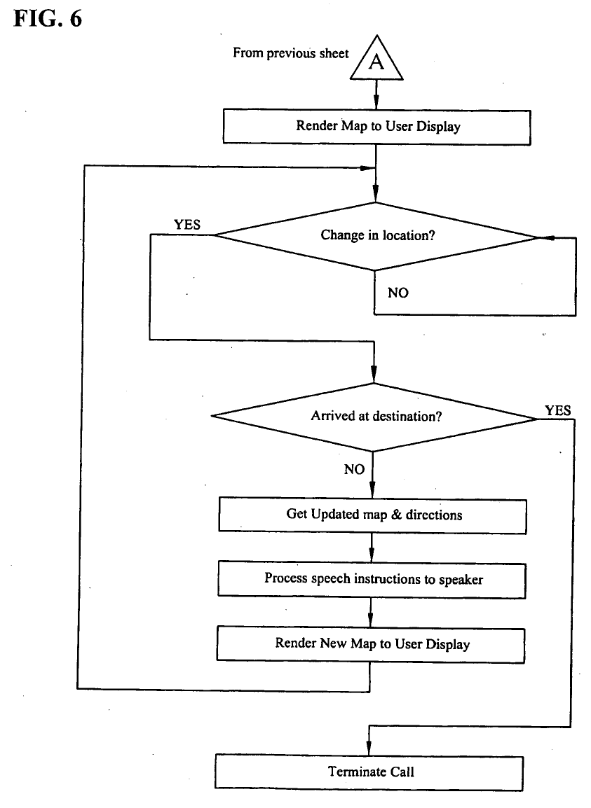

FIG. 7 depicts a block diagram of one embodiment of the invention

FIG. 8 depicts a block diagram of one embodiment of the invention

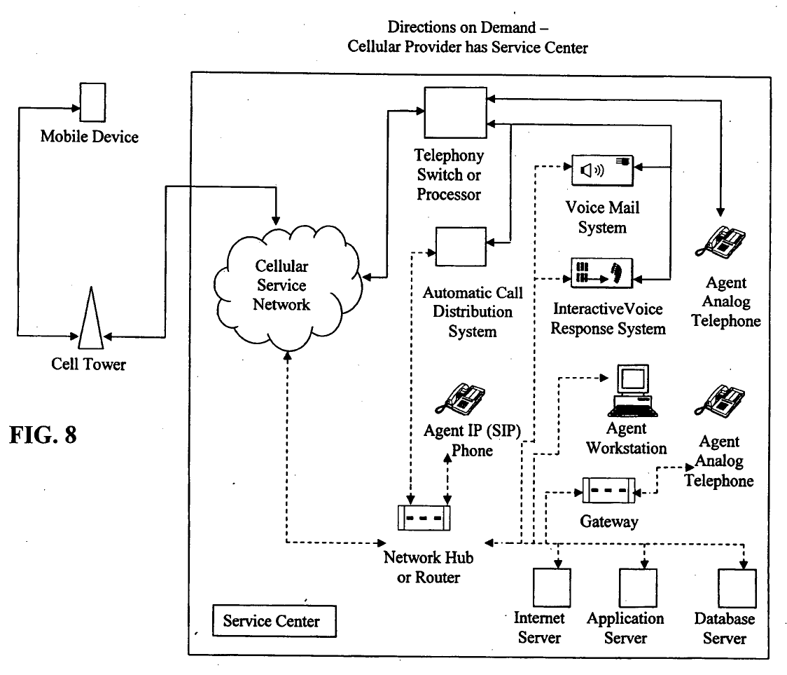

FIG. 9 depicts a block diagram of one embodiment of the invention

FIG. 9A depicts a block diagram of one embodiment of the invention

FIG. 10 depicts a block diagram of one embodiment of the invention

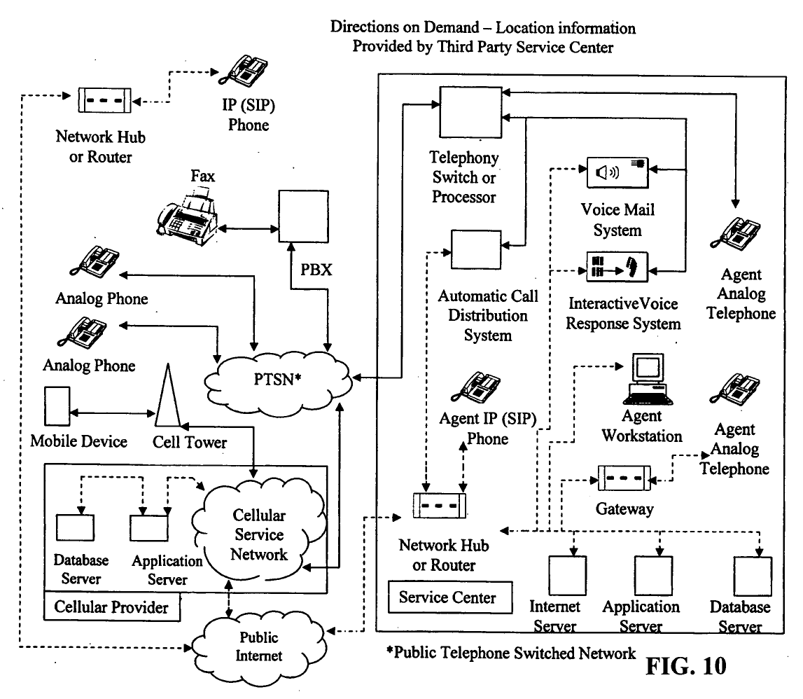

FIG. 11 depicts a flow diagram of one embodiment of the invention

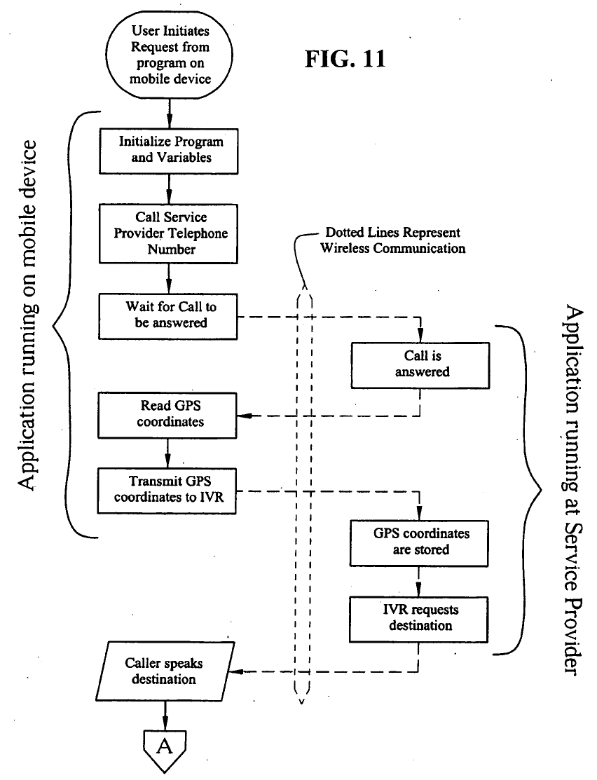

FIG. 12 depicts a flow diagram of one embodiment of the invention

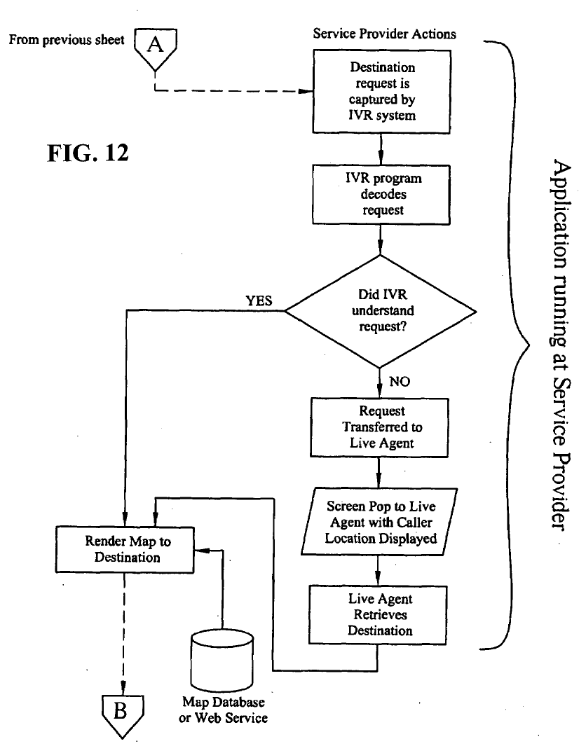

FIG. 13 depicts a flow diagram of one embodiment of the invention

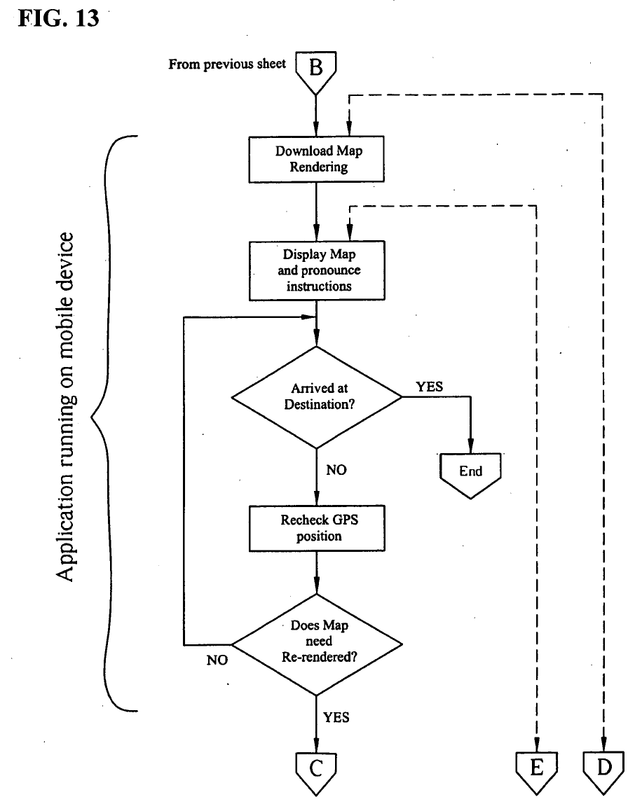

FIG. 14 depicts a flow diagram of one embodiment of the invention

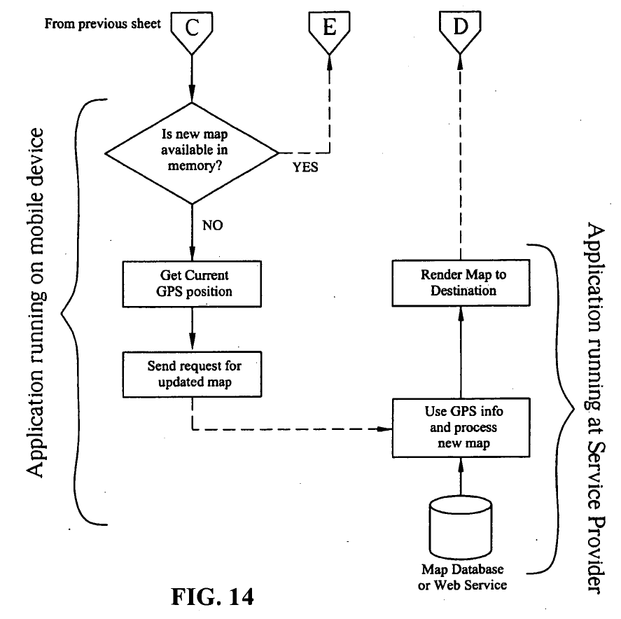

FIG. 15 depicts a flow diagram of one embodiment of the invention

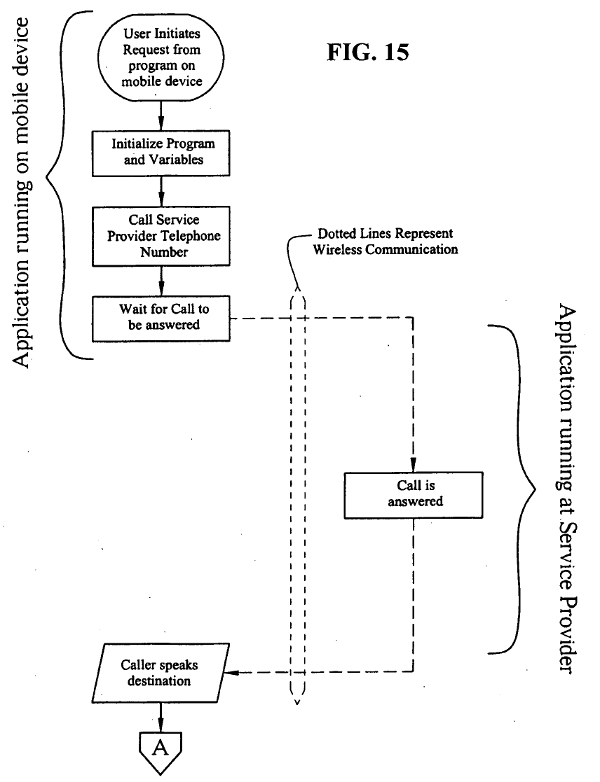

FIG. 16 depicts a flow diagram of one embodiment of the invention

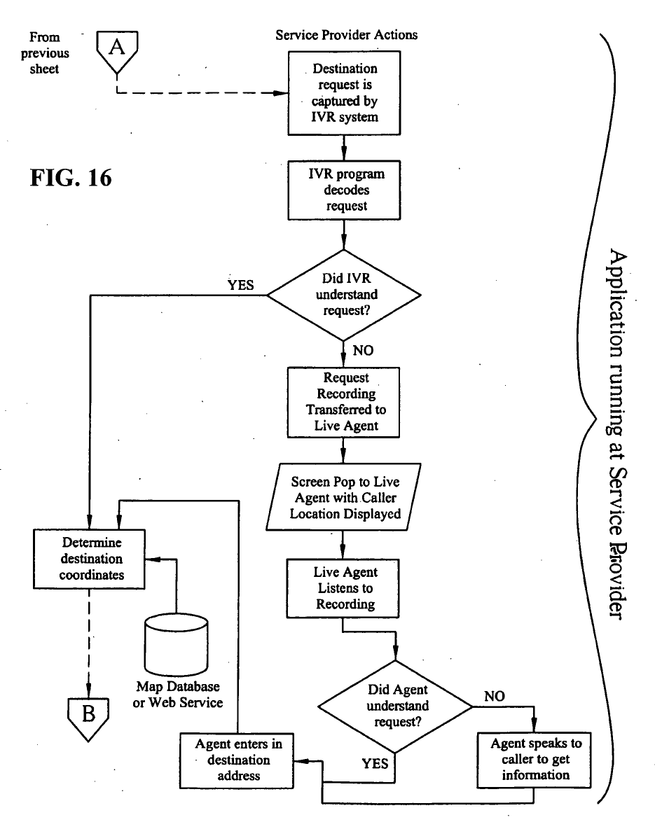

FIG. 17 depicts a flow diagram of one embodiment of the invention

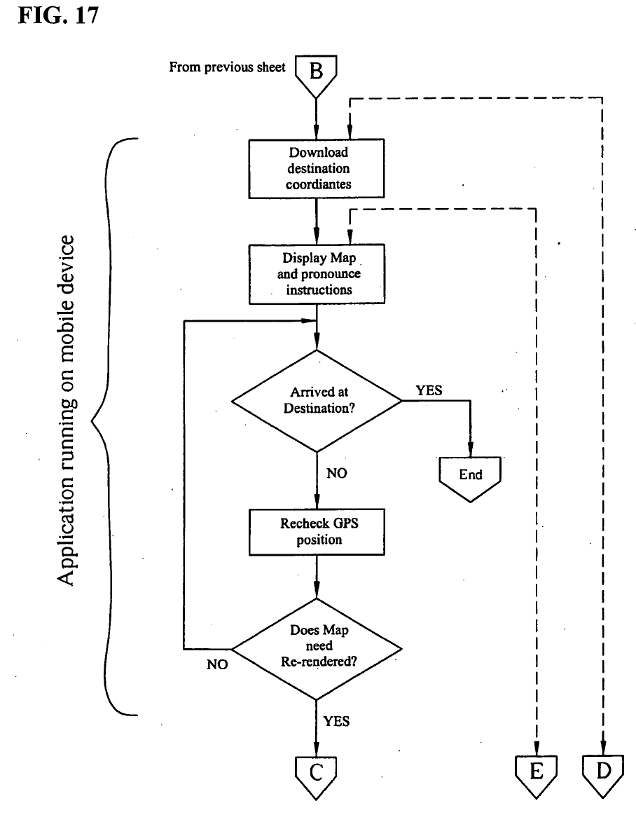

FIG. 18 depicts a flow diagram of one embodiment of the invention

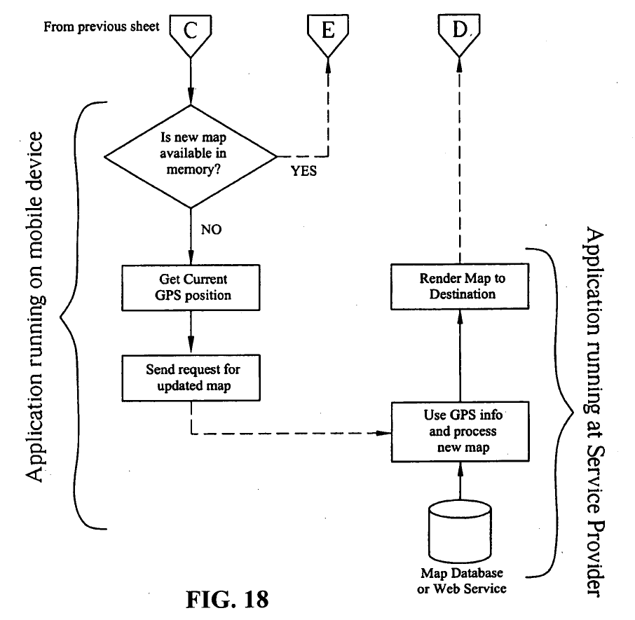

### DETAILED DESCRIPTION

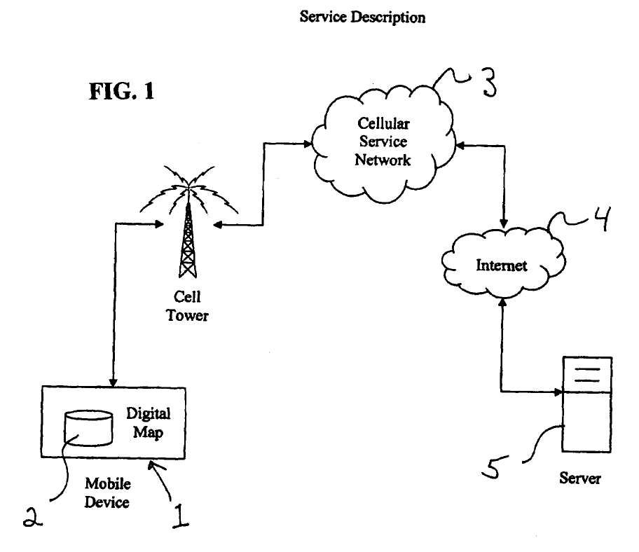

In one embodiment (FIG. 1), Updates to programs and data are available to download.

The mobile device (1) may contain content, embedded speech recognition, GPS navigation, digital maps (2), points of interest, speech recognition, and GPS.

1. user launches application to retrieve directions (application could be a stand alone application or a plug in into internet browser).

2. the user dictates the destination into the cell phone (1). The cell phone processes the speech and responds back to the user with the destination to confirm.

3. the cell phone (1) uses the current location as provided by internal GPS and requested destination to create the directions.

4. user is guided to destination by verbal directions from cell phone (1)

5. updates to programs and data is available via cellular service (3,4,5).

Reference character (5) depicts an update server for digital maps and points of interest applications.

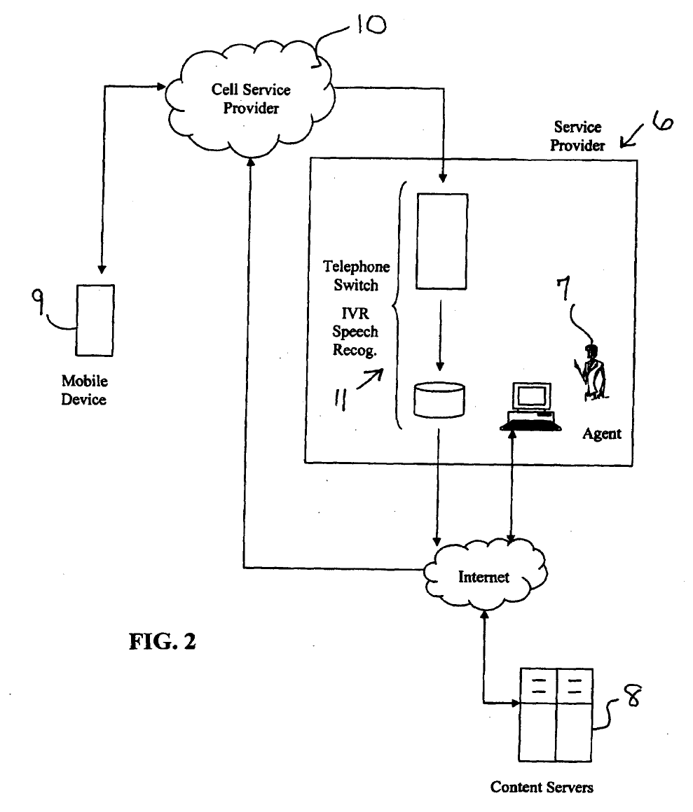

In one embodiment (FIG. 2),

1. caller initiates call

2. the call is connected to the service provider (6)

3. the call request is recorded & processed by speech recognition software (11)

4. if unable to determine location, recording is queued for agent (7)

5. the agent listens to the recorded request

6. the agent enters destination

7. the destination request is sent to map servers (8)

8. the final destination coordinates and digital map is sent

9. map is delivered to cell service provider (10)

10. map is delivered to handset (9)

The content servers (8) include digital maps and points of interest search.

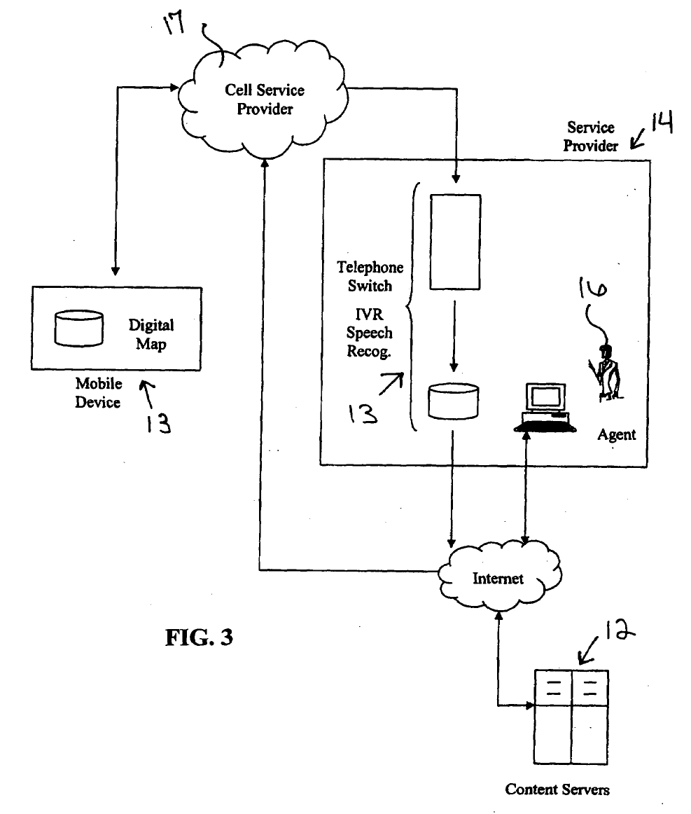

In one embodiment (FIG. 3), the content servers (12) include digital maps and points of interest search. Mobile device (13) may contain content such as digital maps and points of interest search.

1. caller initiates call

2. the call is connected to service provider (14)

3. the call request is recorded & processed by speech recognition software (15)

4. if unable to determine location, the recording is queued for an agent (16)

5. the agent listens to recorded request

6. the agent enters destination

7. the destination request is sent to content servers (12), or back to mobile device (13)

8. the final destination coordinates and digital map is sent to mobile device (13), or retrieved out of mobile device storage memory

9. the map is delivered to cell service provider (17) if supplied by content server (12)

10. the map is delivered to and/or displayed on handset (13)

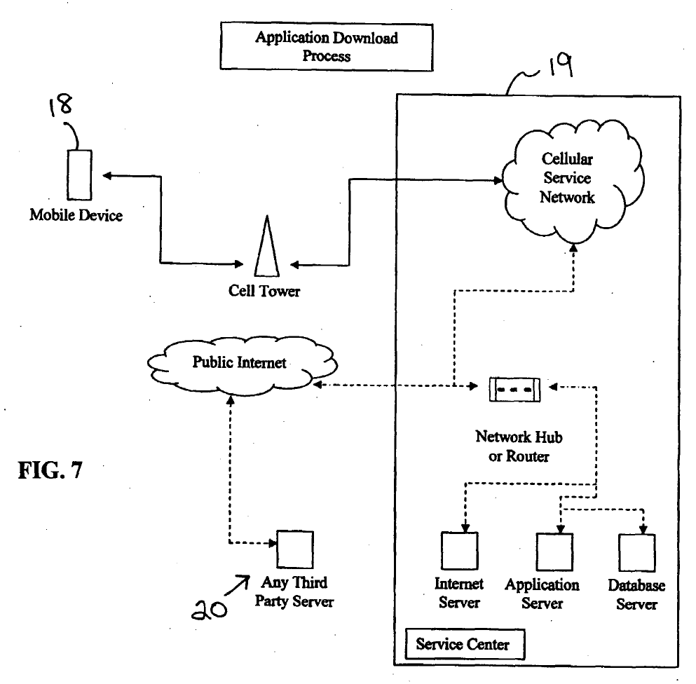

In one embodiment (FIG. 7), Cell phone or personal digital assistant (PDA) device (18) could be running Java, J2ME, or BREW, etc.

1. the application is created and stored on a cellular service provider (19) server or another third party (20)

2. cell phone or PDA user, using browser software or other connectivity software, navigates to site maintained by cellular service provider or other third party provider

3. the cell phone or PDA user downloads the application from the cellular service provider or other third party provider

4. the application automatically installs into the cell phone or PDA (18) and is ready for use

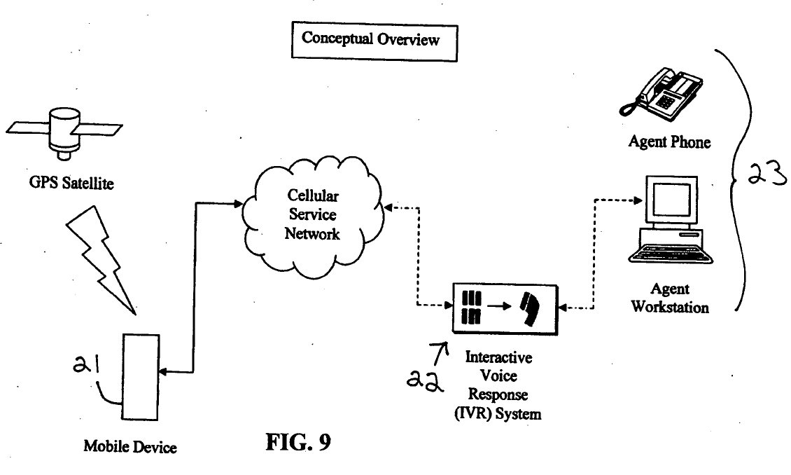

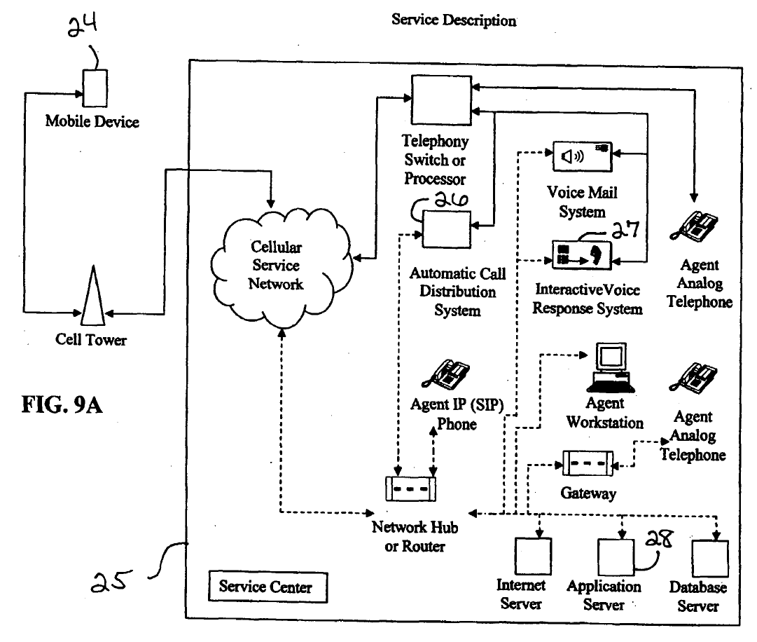

In one embodiment (FIG. 9),

1. user desires directions to a location

2. user contracts service provider from cell phone or PDA (21)

3. the call is processed via an IVR system (22)

4. the IVR receives the caller's current GPS coordinates and stores for later use

5. the IVR processes the GPS coordinates and confirms the caller's location back via text to speech technology

6. the IVR prompts the caller for the destination using text to speech engine

7. the caller dictates the destination into the IVR. the IVR processes the speech and responds back to the caller with the destination to confirm.

8. the caller confirms the destination verbally

9. the IVR processes the request and sends the directions in the form of a digital map and text directions back to the caller's cell phone or PDA (21).

10. if the IVR cannot resolve the destination, the caller is connected to a live agent (23). The live agent then determines the need and sends the digital map and directions back to the caller.

In one embodiment (FIG. 9A),

1. the user launches application to retrieve directions. (application could be a stand alone application or a plug-in into internet browser).

2. the user chooses method of contact, either voice channel or VOIP via built in browser

3. the application on cell phone (24) fetches GPS coordinates and initiates contact to the service center (25).

4. the service center (25) routes via ACD system (26) to the IVR (27). The IVR prompts the caller for the destination

5. the caller dictates the destination into the IVR. The IVR processes the speech and responds back to the caller with the destination to confirm

6. the caller confirms the destination verbally

7. the IVR system (27) sends the caller's location and destination address to the application server (28)

8. the application server (28) uses the caller's location and destination to create the direction

9. the directions are transmitted back to the cell phone (24) as a map and text directions.

1. (canceled)

2. (canceled)

3. A method for providing geographic directions comprising the steps of:
providing a communication device being under the control of a user and having the capability of determining the geographic location thereof, and further having a map server function, and further having speech recognition capabilities;
the communication device performing the steps of,
determining a point of origin by ascertaining the geographic coordinates of the communication device, and matching it to an origin address on the map server,
receiving human speech from the user corresponding to a destination address,
converting the human speech into electronic text and matching the text to a destination address on the map server,
converting the destination address in the form of electronic text into human speech,
reciting the human speech to the user,
upon receiving confirmation of the destination address from the user, reciting in the form of human speech step by step directions from the origin address to the destination address.

4. A method for providing geographic directions comprising the steps of:
providing a server system capable of electronic communication with a communication device;
the server system,
receiving a call from a communication device, the communication device being under the control of a user,
receiving human speech in the form of electronic information from the communication device,
recording the human speech,
converting the human speech into electronic text and attempting to match the text to a destination address on a map server,
upon failing to match the text to a destination address on the map server, transmitting the recorded speech to a human operator who listens to it and ascertains a destination address.

5. The method of claim 4 further comprising:
upon receiving the ascertained destination address, the server system rendering a map from the location of the communication device to the destination address, and transmitting the map to the communication device.

6. The method of claim 4 further comprising:
upon receiving the ascertained destination address, the server system electronically transmitting it to the communication device.

7. A method for providing geographic directions comprising the steps of:
providing a server system capable of electronic communication with a communication device;
the server system,
receiving a call from a communication device, the communication device being under the control of a user,
receiving human speech in the form of electronic information from the communication device,
recording the human speech,
converting the human speech into electronic text and attempting to match the text to a destination address on a map server,
upon failing to match the text to a destination address on the map server, transmitting the recorded speech to a human operator who listens to it and attempts to ascertain a destination address;
upon failing to ascertain a destination address, the human operator speaking directly to the user to ascertain the destination address;
upon receiving the ascertained destination address, the server system rendering a map from the location of the communication device to the destination address, and transmitting the map to the communication device;
upon receiving the map from the server system, the communication device reciting in the form of human speech to the user step by step directions from the origin address to the destination address.
